(19) United States
(12) Patent Application Publication
(10) Pub. No.: US 2001/0003771 A1
(43) Pub. Date: Jun. 14, 2001

(54) Phosphorus-containing flame-retardant cured epoxy resins

(76) Inventors: Chun-Shan Wang, Tainan (TW); Ching Hsuan Lin, Tainan (TW); Hong Chen Chiu, Tainan (TW)

Correspondence Address: T. Ling Chwang, Esq., Jackson Walker, LLP, 2435 N. Central Expressway, Suite 600, 275 West Campbell Road, Richardson, TX, 75080, US

(21) Appl. No.: 09/757,900

(22) Filed: Jan. 10, 2001

Related U.S. Application Data
(63) Continuation-in-part of application No. 09/437,985, filed on Nov. 10, 1999.
Application No. 09/437,985 is a continuation-in-part of application No. 09/261,884, filed on Mar. 3, 1999.

(51) Int. Cl. C08G 59/14

(52) U.S. Cl. 525/523

(57) ABSTRACT

A flame-Retardant advanced epoxy resin was prepared by reacting an active-hydrogen-containing phosphorus compound with a di- or poly-functional epoxy resin via an addition reaction between the active hydrogen and the epoxide group, which has a high glass transition temperature (Tg), high decomposition temperature and high elastic modulus and thus is suitable for printed circuit board and semiconductor encapsulation applications by curing with a curing agent. The active-hydrogen-containing phosphorus compound is 9,10-dihydro-9-oxa-10-phosphaphenanthrene 10-oxide having a chemical structure as follows:

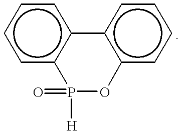

### CROSS-REFERENCE TO RELATED APPLICATION

The present application is a continuation-in-part application of U.S. patent application Ser. No. 09/437,985, filed Nov. 10, 1999, which is a continuation-in-part application of U.S. patent application Ser. No. 09/261,884, field Mar. 3, 1999. The above-listed applications of Ser. Nos. 09/437,985 and 09/261,884 are commonly assigned with the present invention and the entire content of each of which application is incorporated herein by reference.

### FIELD OF THE INVENTION

The present invention relates generally to flame-retardant advanced epoxy resins prepared by reacting an active-hydrogen-containing phosphorus compound with a di- or poly-functional epoxy resin via an addition reaction between the active hydrogen and the epoxide group. The present invention also relates to cured epoxy resins resulting from the advanced epoxy resins, which have excellent flame-retardancy and mechanical properties.

### BACKGROUND OF THE INVENTION

Epoxy resins have the excellent characteristics of moisture, solvent and chemical resistance, toughness, low shrinkage on cure, superior electrical and mechanical resistance properties, and good adhesion to many substrates. The versatility in formulation also make epoxy resins widely applicable industrially for surface coatings, adhesive, painting materials, potting, composites, laminates, encapsulants for semiconductors, and insulating materials for electric devices, etc. o-Cresol formaldehyde novolac epoxy (CNE) is the resin typically employed in the encapsulation of microelectronic devices. Several approaches for modification of epoxy backbone for enhancing the thermal properties of epoxy resins have been reported. Aromatic bromine compounds in conjunction with antimony oxide are widely used as a flame retardant for epoxy resins. Tetrabromobisphenol A is a typical example of the aromatic bromine compounds used as a flame retardant for epoxy resins. An excess amount of epoxy resin is reacted with tetrabromobisphenol A to prepare an advanced epoxy resin having two terminal epoxide groups, as shown in the following formula:

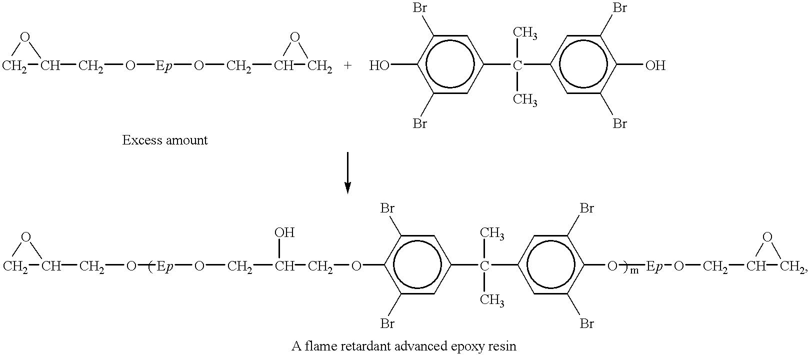

wherein EP is a bi-radical group of the backbone of the epoxy resin, and m is an integer of 1-10. The advanced epoxy resin can be used in preparing a flame-retardant printed circuit board (FR-4) by impregnating glass fibers with the advanced epoxy resin and heating the resulting composite to cure the advanced epoxy resin. Furthermore, the advanced epoxy resin can be employed to encapsulate microelectronic devices, in which the advanced epoxy resin is cured at a high temperature with a curing agent, so that an encapsulant having a flame-retardant property is formed. Typical examples can be found in U.S. Pat. No. 3,040,495 (1961); U.S. Pat. Nos. 3,058,946 (1962); 3,294,742 (1966); 3,929,908 (1975); 3,956,403 (1976); 3,974,235 (1976); 3,989,531 (1976); 4,058,507 (1997); 4,104,257 (1978); 4,170,711 (1979); and 4,647,648(1987)].

Although the tetrabromobisphenol A-containing advanced epoxy resin shows flame retardant property, major problems encountered with this system are concerned with the generation of toxic and corrosive fumes during combustion such as dioxin and benzofuran.

The flame retardant having a small molecular weight tends to degrade the mechanical properties of the epoxy resins, and migrate/vaporize from the epoxy resins such that the flame retardancy thereof diminishes.

Owing to organic phosphorus compounds generate less toxic gas and smoke than halogen-containing compounds, some authors have reported advanced epoxy resins containing phosphorus compound [Japanese patent application publication No. 10-30017 (1998), Japanese patent application publication No. 10-30016 (1998), Japanese patent application publication No. 10-152545 (1998)]. One example of the reaction is shown in the following scheme [Japanese patent application publication No. 10-30017 (1998)]:

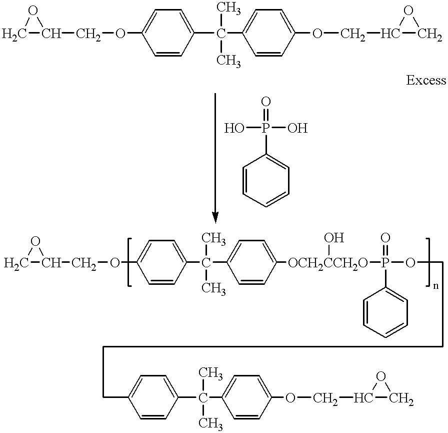

Although these phosphorus containing advancement epoxy resins exhibited good flame retardancy, they were all derived from the reaction between aromatic phenol and epoxy group. For a multifuntional epoxy resin (functionality>2), this advancement reaction may lead to gel if the reaction is not controlled well. These advancement epoxy resins yield low Tg product because they are derived from difunctional DGEBA (diglycidyl ether bisphenol A epoxy resin )and also due to their high EEW (epoxide equivalent weight) (EEW>400 g/eq). In order to increase their Tg (glass transition temperature), multifunctional epoxy resin has to be added into these advanced resins. The blending of a multifunctional epoxy into these advanced resins may result in phase separation due to the difference in the reactivity between the multifuntional epoxy resin and the advanced epoxy resin toward the curing agent. The trend of electronics equipment is being miniaturized and becoming thinner, at the same time the scale of integration of large scale integrated circuits (LSICs) is continuing upward, forcing the design toward larger chips, finer patterns, and higher pin counts that are more susceptible to a high-temperature failure. The prevailing surface mount technology (SMT) also causes the devices being subjected to a high temperature. Therefore, the development of a high-temperature reliable, flame-retardant and environmentally friendly epoxy resin for printed circuit board and encapsulant are essential for semiconductor industry.

It is an object of this invention to provide flame retardant advanced epoxy resins and cured epoxy resins with good thermal stability, superior heat resistance, and environment friendly, which are suitable for use in making printed circuit boards and in semiconductor encapsulation applications.

It is another object of this invention to provide a method for improving flame retardant properties of epoxy resins.

### SUMMARY OF THE INVENTION

In order to accomplish the aforesaid objects, a flame retardant advanced epoxy resin and a cured epoxy resin were synthesized in the prevent invention.

The flame-retardant advanced epoxy resin was prepared by reacting a phosphorus-containing compound having an active hydrogen connected directly to the phosphorus atom with a di- or poly-functional epoxy resin via an addition reaction between the active hydrogen and the epoxide group. The flame-retardant cured epoxy resin prepared from this advanced epoxy resin has a high glass transition temperature (Tg), high decomposition temperature and high elastic modulus, and is free of toxic and corrosive fumes during combustion, and thus is suitable for printed circuit board and semiconductor encapsulation applications. The active-hydrogen-containing phosphorus compound is 9,10-dihydro-9-oxa-10-phosphaphenanthrene 10-oxide having a chemical structure (I) as follows:

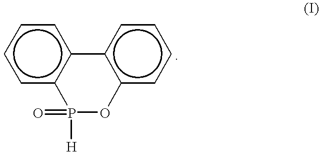

### DETAILED DESCRIPTION OF THE INVENTION

A phosphorus-containing flame-retardant advanced epoxy resin prepared in accordance with the present invention has a structure selected from the group consisting of formulas (a) to (d):

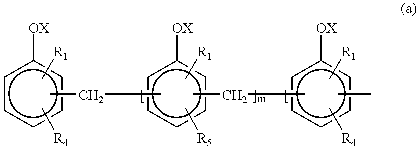

wherein:

m is an integer from 1 to 12; R₁=H or C₁-C₄ hydrocarbon radical; R₄ and R₅ are, independently, hydrogen, methyl or

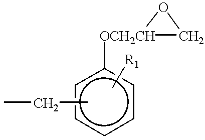

wherein R₁ is defined as above; and

X=A or B, and at least one of X is B, wherein

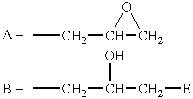

wherein E is

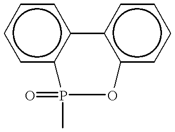

wherein X is defined as above; and Q is

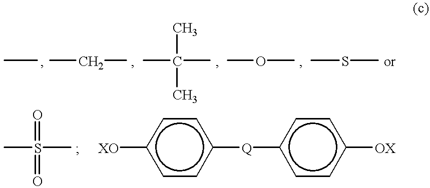

wherein X and Q are defined as above; and

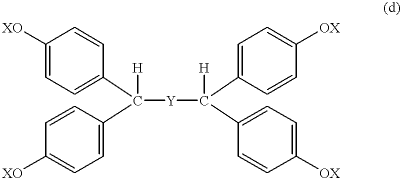

wherein X is defined as above; and Y is —(CH₂)ₙ— or phenylene, wherein n is an integer of 0 to 6.

Preferably, the flame-retardant advanced epoxy resin has the formula (a), and R₁ is hydrogen, —CH₃, and R₄ is hydrogen.

Preferably, the flame-retardant advanced epoxy resin has the formula (c), and Q is —C(CH₃)₂—.

Preferably, the flame-retardant advanced epoxy resin contains 0.2-30 wt %, and more preferably, 0.5-10 wt % phosphorus. A suitable process for preparing the phosphorus-containing flame-retardant advanced epoxy resin of the present invention comprises reacting an active-hydrogen-containing phosphorus compound, (9,10-dihydro-9-oxa-10-phosphaphenanthrene 10-oxide, DOPO), having the following formula (I)

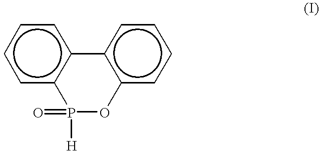

with an epoxy resin having a formula selected from the group consisting of (a′) to (d′) in a molten state or in a common solvent and without or in the presence of a catalyst:

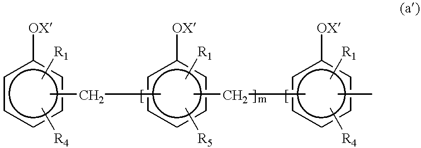

wherein:

m is an integer and 0<m<12:R₁=H or C₁-C₄hydrocarbon radical:R₄ and R₅ independently are hydrogen, methyl or

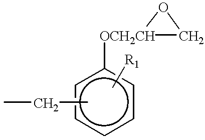

wherein R₁ has the same definition as above; and

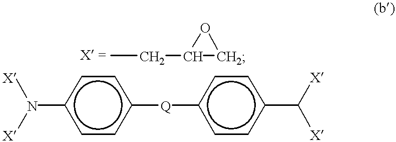

wherein X′ is defined the same as above; and Q is

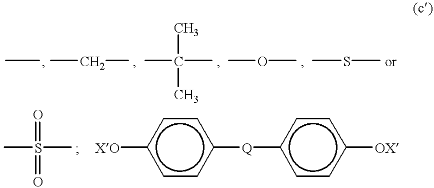

wherein X′ and Q are defined as above; and

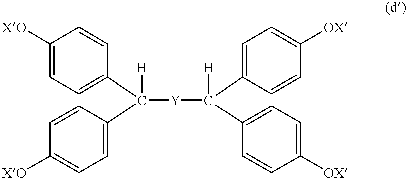

wherein X′ is defined as above; and Y is —(CH₂)ₙ— or phenylene, wherein n is an integer of 0 to 6.

In the process for preparing the phosphorus-containing flame-retardant advanced epoxy resin of the present invention, the active hydrogen of the phosphorus compound, DOPO, reacts with the epoxide groups of the epoxy resin via an addition reaction, as shown in the following scheme (II), and thus both a di- and poly-functional epoxy resin can be used in the present invention.

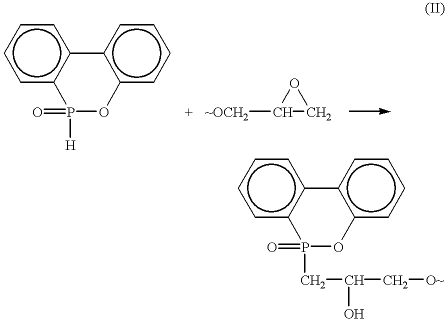

Preferably, the reaction (II) is carried out at 100° C.-200° C., and with the epoxide group in the epoxy resin (selected from (a′) to (d′)) to the active hydrogen connected to the phosphorous in the phosphorus-containing compound (I) in an equivalent ratio of ranging from 2:1 to 10:1. This reaction (II) may be carried out in the presence of a catalyst selected from the group consisting of 2-phenylimidazole, 2-methylimidazole, triphenylphosphine, a quarternary phosphoium compound and a quarternary ammonium compound. Examples of the quarternary phosphoium compound include ethyltriphenyl phosphonium acetate and ethyltriphenyl phosphonium halides. Examples of the quarternary ammonium compound are benzyltrimethyl ammonium chloride, benzyltriethyl ammonium chloride and tetrabutyl ammonium chloride. The flame-retardant advanced epoxy resin prepared in the present invention can be used in preparing a flame-retardant printed circuit board (FR-4) as a matrix resin by impregnating glass fibers with the advanced flame-retardant epoxy resin and a curing agent, then curing the resulting composite.

The present invention further synthesized a phosphorus-containing flame-retardant cured epoxy resin by curing the phosphorus-containing flame-retardant advanced epoxy resin of the present invention with a curing agent of an epoxy resin. The curing agent can be any curing agent used in the art for curing an epoxy resin, and preferably is selected from the group consisting of melamine-phenol novolac, phenol-formaldehyde novolac, dicyandiamide, methylenedianiline, diaminodiphenyl sulfone, phthalic anhydride and hexahydrophthalic anhydride. Preferably, the curing reaction is carried out at a temperature higher than 150° C. and with a stoichiometric amount of the curing agent, i.e. the equivalent ratio of the epoxide group in the advance epoxy resin and the functional groups in the curing agent is about 1:1. More preferably, the curing reaction is carried out in the presence of a curing promoter such as triphenylphosphine, and in an amount of 0.01-10.0 parts by weight of the curing promoter per 100 parts by weight of the advance epoxy resin. The phosphorus-containing flame-retardant cured epoxy resin of the present invention is suitable for use in semiconductor encapsulation.

A suitable epoxy resin for use in the present invention can be any known epoxy resin, for examples those having two epoxide groups such as bisphenol A epoxy resin, bisphenol F epoxy resin, bisphenol S epoxy resin and biphenol epoxy resin, and those having more than two epoxide groups such as phenol formaldehyde novolac epoxy and cresol formaldehyde novolac epoxy (CNE) with 4-18 functional groups, and mixtures thereof.

I. Preparation of phosphorus-containing Flame-Retardant advanced epoxy resin

### EXAMPLE 1

### Advanced epoxy resin IIP₁ (phosphorus content 1 wt %) prepared from diglycidyl ether of bisphenol A (DGEBA) and DOPO

To a one liter four-neck round-bottom flask equipped with a heating mantle, a thermocouple and temperature controller, a reflux condenser, a nitrogen feed, a vacuum system and a mechanical stirrer, 700 g diglycidyl ether of bisphenol A (DGEBA) having an epoxide equivalent weight (EEW) of 187 g/eq was added, and heated to 110° C. while stirring and vacuuming (<100 mmHg) for a period of 30 minutes to remove a trace amount of water contained in the epoxy resin. The vacuuming was stopped, and dried nitrogen was introduced into the flask until the atmospheric pressure was reached. The temperature of the flask was raised to 130° C., and 52.5 g of 9,10-dihydro-9-oxa-10-phosphaphenanthrene-10-oxide (DOPO, purchased from TCI) was then added while stirring. The temperature of the reaction mixture was gradually increased to 160° C. and maintained at that temperature for five hours. A phosphorus containing advanced epoxy resin IIP₁ with EEW 215 g/eq was obtained after cooling (216 g/eq theoretically).

### EXAMPLES 2-3

### Preparation of advanced epoxy resins IIP₂ (phosphorus content 2 wt %) and IIP₃ (phosphorus content 3 wt %)

The procedures described in Example 1 were repeated, except that the amount of DOPO was changed to 113.5 g and 185 g in Examples 2 and 3, respectively. The resultant product IIP₂ (Example 2) has a phosphorus content of 2 wt % and EEW of 252 g/eq (252 g/eq theoretically). The resultant product IIP₃ (Example 3) has a phosphorus content of 3 wt % and EEW of 308 g/eq (306 g/eq theoretically).

### EXAMPLE 4

### Advanced epoxy resin C₁₂P₂ (phosphorus content 2 wt %) prepared from cresol formaldehyde novolac epoxy resin (CNE) and DOPO

To a one liter four-neck round-bottom flask equipped with a heating mantle, a thermocouple and temperature controller, a reflux condenser, a nitrogen feed, a vacuum system and a mechanical stirrer, 400 g cresol formaldehyde novolac epoxy resin (CNE, available from Nan Ya Plastics Co., Taiwan, under a code name of NPCN-704) having an epoxide equivalent weight (EEW) of 205 g/eq and functionality of 12 was added, and heated to 110° C. while stirring and vacuuming (<100 mmHg) for a period of 30 minutes to remove a trace amount of water contained in the epoxy resin. The vacuuming was stopped, and dried nitrogen was introduced into the flask until the atmospheric pressure was reached. The temperature of the flask was raised to 130° C., and 68 g of 9,10-dihydro-9-oxa-10-phosphaphenanthrene-10-oxide (DOPO, purchased from TCI) was then added while stirring. The temperature of the reaction mixture was gradually increased to 160° C. and maintained at that temperature for 2.5 hours. A phosphorus containing advanced epoxy resin C₁₂P₂ with EEW 275 g/eq was obtained after cooling (285 g/eq theoretically).

### EXAMPLE 5

### Preparation of advanced epoxy resin C₁₂P₄ (phosphorus content 4 wt %)

The procedures described in Example 4 were repeated, except that the amount of DOPO was changed to 155 g. The resultant product C₁₂P₄ has a phosphorus content of 4 wt % and EEW of 485 g/eq (464 g/eq theoretically).

The reaction in Examples 4 and 5 is shown as follows:

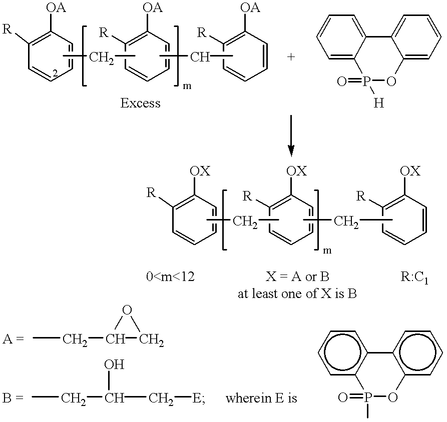

II. Curing of the advanced epoxy resins

Cured epoxy resins were prepared separately from the advanced epoxy resins prepared in Examples 1-5, DGEBA (control) and CNE (control) with a curing agent in a 1:1 equivalent ratio. The curing agent was selected from diaminodiphenyl sulfone (DDS), phenol-formaldehyde novolac having an OH equivalent weight of 105 g/eq (PN) or dicyandiamide (DICY). The mixture was grounded into fine powder and then heated on a hot plate at about 150° C. with a continuous stirring until a homogenous solution was obtained. DDS and DICY curing systems did not require a curing accelerator, but for PN curing system, 0.2 wt % of triphenylphosphine was added and stirred prior to heating. The homogenous solution was poured into an aluminum mold and then cured in an oven.

For the advanced epoxy resins prepared from DGEBA (Examples 1-3) and the pure DGEBA epoxy resin (control) the curing was conducted at 160° C. for one hour, and 180° C. for four hours. For the advanced epoxy resins prepared from CNE (Examples 4-5) the curing was conducted at 160° C. for one hour, 180° C. for two hours and 200° C. for two hours. Additional two hours at 200° C. was applied for the pure CNE epoxy resin (control). The samples were allowed to cool slowly to room temperature in order to prevent cracking.

The dynamic mechanical analysis (DMA) properties of the resulting cured epoxy resins in Examples 1-3 and the control (DGEBA) are shown in Table 1; the thermogravimetric analysis data thereof are shown in Table 2; and the flame-retardant properties thereof are shown in Table 3.

TABLE 1
DMA properties

| | Glass transition temperature | Modulus |
|---|---|---|
| Samples | (Tg, ° C.) | 50° C., × 10⁸ Pa |
| DGEBA/DDS | 190 | 18.8 |
| IIP₁/DDS | 188 | 19.2 |
| IIP₂/DDS | 155 | 20.4 |
| IIP₃/DDS | 124 | 18.1 |
| DGEBA/PN | 151 | 16.4 |
| IIP₁/PN | 134 | 18.4 |
| IIP₂/PN | 129 | 21.3 |
| IIP₃/PN | 117 | 17.7 |

TABLE 2
TGA data

| | | | Char yield at | Char yield at |
|---|---|---|---|---|
| | Td 5% ° C. | Td 5% ° C. | 700° C. (%) | 700° C. (%) |
| Samples | N₂ | Air | N₂ | Air |
| DGEBA/DDS | 405 | 379 | 15.1 | 0 |
| IIP₁/DDS | 388 | 375 | 15.93 | 4 |
| IIP₂/DDS | 386 | 363 | 17.64 | 11.3 |
| IIP₃/DDS | 375 | 356 | 20 | 18.7 |
| DGEBA/PN | 423 | 417 | 19.1 | 0 |
| IIP₁/PN | 396 | 386 | 22.5 | 15.9 |
| IIP₂/PN | 371 | 383 | 25 | 19.5 |
| IIP₃/PN | 366 | 364 | 26.9 | 20.7 |

TABLE 3
UL-94 test and LOI (limiting oxygen index) measurement

| | | UL-94 test | | | |
|---|---|---|---|---|---|
| | | 1^{st} burning | 2^{nd} burning | UL-94 | |
| Samples | P % | time^{a} | time^{a} | grade | LOI |
| DGEBA/DDS | 0 | >60 | — | V-2 | 22 |
| IIP₁/DDS | 0.78 | 9.5 | 5.3 | V-1 | 25 |
| IIP₂/DDS | 1.60 | 6.3 | 3.1 | V-0 | 28 |
| IIP₂/DDS | 2.49 | 2.1 | 0.9 | V-0 | 30 |
| DGEBA/PN | 0 | >80 | — | HB^{b} | 21 |
| IIP₁/PN | 0.67 | 53 | — | V-2 | 23 |
| IIP₂/PN | 1.41 | 19.2 | 4.5 | V-1 | 25 |
| IIP₃/PN | 2.23 | 2.1 | 1.1 | V-0 | 27 |

^{a}the burning time (sec) after they are fired for 10 sec.
^{b}heavy burning

The dynamic mechanical analysis (DMA) properties of the resulting cured epoxy resins in Examples 4-5 and the control (CNE) are shown in Table 4; the thermogravimetric analysis data thereof are shown in Table 5; and the flame-retardant properties thereof are shown in Table 6.

TABLE 4
DMA properties

| | Glass transition temperature | Modulus | | | |
|---|---|---|---|---|---|
| Samples | (Tg, ° C.) | 50° C., × 10⁸ Pa | | | |
| CNE/DDS | 255 | 1.02 | | | |
| C₁₂P₂/DDS | 228 | 1.06 | | | |
| C₁₂P₄/DDS | 178 | 1.05 | | | |
| CNE/PN | 216 | 2.12 | | | |
| C₁₂P₂/PN | 178 | 2.89 | | | |
| C₁₂P₄/PN | 155 | 2.37 | CNE/DICY | 248 | 1.23 |
| C₁₂P₂/DICY | 213 | 1.78 | | | |
| C₁₂P₄/DICY | 169 | 1.25 | | | |

TABLE 5
TGA data

| | | | Char yield at | Char yield at |
|---|---|---|---|---|
| | Td 5% ° C. | Td 5% ° C. | 700° C. (%) | 700° C. (%) |
| Samples | N₂ | Air | N₂ | Air |
| C₁₂/DDS | 407 | 416 | 29.9 | 0 |
| C₁₂P₂/DDS | 386 | 387 | 42.3 | 25 |
| C₁₂P₄/DDS | 371 | 374 | 43.6 | 29.5 |
| C₁₂/PN | 407 | 408 | 40.1 | 0 |
| C₁₂P₂/PN | 391 | 394 | 47.6 | 35 |
| C₁₂P₄/PN | 376 | 378 | 46.7 | 41 |
| C₁₂/DICY | 373 | 380 | 29.3 | 2.2 |
| C₁₂P₂/DICY | 363 | 370 | 33.7 | 21.4 |
| C₁₂P₄/DICY | 364 | 370 | 35.0 | 27.9 |

TABLE 6
UL-94 test and LOI (limiting oxygen index) measurement

| Samples | P % | Drip or not | Fume or not | Grade | LOI |
|---|---|---|---|---|---|
| C₁₂/DDS | 0 | Yes | Yes | V-2 | 23 |
| C₁₂P₂/DDS | 1.69 | No | No | V-0 | 27 |
| C₁₂P₄/DDS | 3.63 | No | No | V-0 | 33 |
| C₁₂/PN | 0 | Yes | No | V-2 | 21 |
| C₁₂P₂/PN | 1.45 | No | No | V-0 | 26 |
| C₁₂P₄/PN | 3.29 | No | No | V-0 | 28 |
| C₁₂/DICY | 0 | Yes | No | V-2 | 24 |
| C₁₂P₂/DICY | 1.86 | No | No | V-0 | 34 |
| C₁₂P₄/DICY | 3.83 | No | NO | V-0 | 38 |

Tables 1 to 6 show that the cured epoxy resins of the present invention have good mechanical and thermal properties, and have excellent flame retardant properties, especially no fume and dripping occur in the combustion test, and thus are very suitable for the printed circuit board fabrication, semiconductor encapsulation and other industrial applications.

In the other embodiments of the present invention, the procedures of Examples 4 and 5 were repeated except that a cresol formaldehyde novolac epoxy resin of NPCN-703 (CNE, available from Nan Ya Plastics Co., Taiwan) having a functionality of 8 was used to replace the NPCN-704 CNE. Similar results were obtained in comparison with those shown in Tables 4 to 6.

### EXAMPLE 6

### Advanced epoxy resins C₈P₁ (phosphorus content 1 wt %), C₈P₂ (phosphorus content 2 wt %), and C₈P₃ (phosphorus content 3 wt %) prepared from cresol formaldehyde novolac epoxy resin (CNE) and DOPO

The procedures of Example 4 were repeated with various amounts of DOPO to prepare advanced epoxy resins C₈P₁ (phosphorus content 1 wt %), C₈P₂ (phosphorus content 2 wt %), and C8P₃ (phosphorus content 3 wt %), except that a cresol formaldehyde novolac epoxy resin of NPCN-703 (CNE, available from Nan Ya Plastics Co., Taiwan) having an epoxide equivalent weight (EEW) of 220 g/eq and functionality of 8 was used to replace the NPCN-704 CNE. The EEW's of C₈P₁, C₈P₂, and C₈P₃ are 235.44, 291.6 and 361.57 g/eq, respectively.

Cured epoxy resins were prepared separately from the advanced epoxy resins prepared in Example 6 and CNE (control) with a curing agent in a 1:1 equivalent ratio and in the presence of 0.1 part by wieght of triphenylphosphine as a promoter per 100 parts by weight of the advanced epoxy resin. The curing agent was selected from phenol-formaldehyde novolac having an OH equivalent of 105 q/eq (PN) or melamine-phenol novolac (MPN-1 and MPN-2) having the following formula

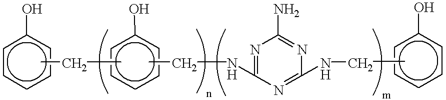

wherein

| | n/m | n | m | % nitrogen | AHEW* |
|---|---|---|---|---|---|
| MPN-1 | 2.83 | 3.31 | 1.87 | 19.28 | 88 |
| MPN-2 | 1.7 | 1.87 | 2.26 | 26.76 | 82 |

*AHEW: active hydrogen equivalent weight

The mixture was grounded into fine powder and then heated on a hot plate at about 130° C. with a continuous stirring until a homogenous solution was obtained. The homogenous solution was poured into an aluminum mold and then cured in an oven.

The curing was conducted at 160° C. for one hour, 180° C. for two hours and 220° C. for two hours. Additional two hours at 200° C. was applied for the pure CNE epoxy resin (control). The samples were allowed to cool slowly to room temperature in order to prevent cracking.

The thermogravimetric analysis (TGA) data thereof are shown in Table 7; and the flame-retardant properties thereof are shown in Table 8.

TABLE 7
TGA data

| | | | | Temperature | | | |
|---|---|---|---|---|---|---|---|
| | | | | of 10 wt % | | Char yield at | |
| Epoxy/curing | Tg | P | N | loss, ° C. | | 700° C., (%) | |
| agent | (° C.) | (%) | (%) | N₂ | Air | N₂ | Air |
| C8/PN | 178.16 | 0 | 0 | 448.3 | 449.2 | 29.04 | 1.36 |
| C8P1/PN | 159.82 | 0.69 | 0 | 443.7 | 443.4 | 30.64 | 14.98 |
| C8P2/PN | 149.65 | 1.47 | 0 | 433.1 | 437.7 | 31.36 | 22.47 |
| C8P3/PN | 137.73 | 2.32 | 0 | 423.5 | 428.2 | 36.7 | 30.13 |
| C8/MPN-1 | 197.21 | 0 | 5.71 | 425.6 | 428.7 | 31.06 | 1.79 |
| C8P1/MPN-1 | 179.66 | 0.73 | 5.43 | 421 | 423.9 | 32.82 | 17.51 |
| C8P2/MPN-1 | 169.33 | 1.54 | 4.64 | 412.4 | 415.7 | 33.13 | 24.22 |
| C8P3/MPN-1 | 156.52 | 2.41 | 3.91 | 401.6 | 411.2 | 39.84 | 32.7 |
| C8/MPN-2 | 205.82 | 0 | 7.33 | 407.9 | 426.1 | 33.29 | 1.946 |
| C8P1/MPN-2 | 183.06 | 0.74 | 6.97 | 406.8 | 415.1 | 33.95 | 19.57 |
| C8P2/MPN-2 | 171.26 | 1.56 | 5.92 | 391.6 | 413.1 | 34.03 | 27.68 |
| C8P3/MPN-2 | 162.91 | 2.44 | 4.97 | 382.5 | 403.8 | 41.31 | 35.69 |

TABLE 8
UL-94 test

| Epoxy/curing | P | N | | Visible | UL-94 | |
|---|---|---|---|---|---|---|
| agent | (%) | (%) | Drip | smoke | grade | LOI |
| C8/PN | 0 | 0 | Heavy | Heavy | V-2 | 21 |
| C8P1/PN | 0.69 | 0 | Slight | Slight | V-1 | 23 |
| C8P2/PN | 1.47 | 0 | No | No | V-0 | 25 |
| C8P3/PN | 2.32 | 0 | No | No | V-0 | 27 |
| C8/MPN-1 | 0 | 5.71 | Slight | Heavy | V-2 | 23 |
| C8P1/MPN-1 | 0.73 | 5.43 | No | No | V-0 | 26 |
| C8P2/MPN-1 | 1.54 | 4.64 | No | No | V-0 | 30 |
| C8P3/MPN-1 | 2.41 | 3.91 | No | No | V-0 | 34 |
| C8/MPN-2 | 0 | 7.33 | Slight | Heavy | V-2 | 24 |
| C8P1/MPN-2 | 0.74 | 6.97 | No | No | V-0 | 27 |
| C8P2/MPN-2 | 1.56 | 5.92 | No | No | V-0 | 32 |
| C8P3/MPN-2 | 2.44 | 4.97 | No | No | V-0 | 36 |

It can be seen from Tables 7 and 8 that a less phosphorus content in the nitrogen-phosphorus-containing cured epoxy resin (C₈Pₓ/MPN) of the 5 present invention is needed to exhibit the same flame-retardant effect compared to the phosphorus-containing cured epoxy resin (C₈Pₓ/PN) due to the synergistic effect resulting from nitrogen and phosphorus elements. However, both the phosphorus-containing and the nitrogen-phosphorus-containing cured epoxy resin specimens of the present invention generate 10 much less fumes in the combustion test in comparison with the conventional cured epoxy resin (C₈/PN, C₈/MPN).

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

What is claimed is:

1. A phosphorus-containing flame-retardant cured epoxy resin prepared by curing, with a curing agent, a phosphorus-containing flame-retardant advanced epoxy resin having a structure selected from the group consisting of formulas (a) to (d): 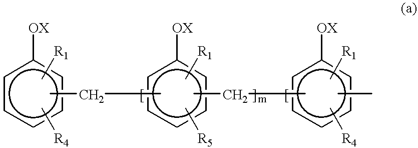
wherein:
m is an integer from 1 to 12; R₁=H or C₁-C₄ hydrocarbon radical; R₄ and R₅ are, independently, hydrogen, methyl or 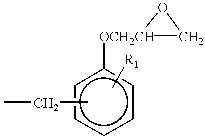
wherein R₁ is defined as above; and
X=A or B, and at least one of X is B, wherein 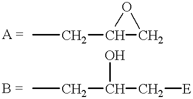
wherein E is 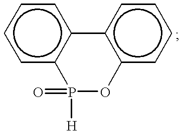 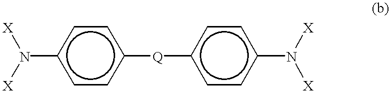
wherein X is defined as above; and Q is 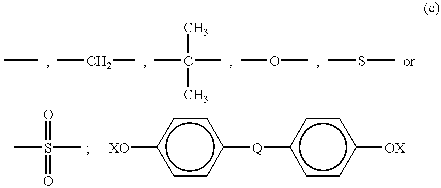
wherein X and Q are defined as above; and 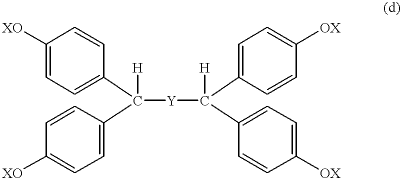
wherein X is defined as above; and Y is —(CH₂)ₙ— or phenylene, wherein n is an integer of 0 to 6.

2. The flame-retardant cured epoxy resin according to claim 1, wherein the curing agent is selected from the group consisting of melamine-phenol novolac, phenol-formaldehyde novolac, dicyandiamide, methylenedianiline, diaminodiphenyl sulfone, phthalic anhydride and hexahydrophthalic anhydride.

3. The flame-retardant cured epoxy resin according to claim 1, wherein the curing is carried out at a temperature higher than 150° C. and with a stoichiometric amount of the curing agent.

4. The flame-retardant cured epoxy resin according to claim 1, wherein the flame-retardant advanced epoxy resin has the formula (a), and R₁ is —CH₃, and R₄ is hydrogen.

5. The flame-retardant cured epoxy resin according to claim 4, wherein the flame-retardant advanced epoxy resin contains 0.2-30 wt % phosphorus.

6. The flame-retardant cured epoxy resin according to claim 5, wherein the flame-retardant advanced epoxy resin contains 0.5-10 wt % phosphorus.

7. The flame-retardant cured epoxy resin according to claim 1, wherein the flame-retardant advanced epoxy resin has the formula (c), and Q is —C(CH₃)₂—.

8. The flame-retardant cured epoxy resin according to claim 7, wherein the flame-retardant advanced epoxy resin contains 0.2-30 wt % phosphorus.

9. The flame-retardant cured epoxy resin according to claim 8, wherein the flame-retardant advanced epoxy resin contains 0.5-10 wt % phosphorus.

10. The flame-retardant cured epoxy resin according to claim 1, wherein the curing is carried out in the presence of a curing promoter and in an amount of 0.01-10.0 parts by weight of the curing promoter per 100 parts by weight of the advanced epoxy resin.

11. The flame-retardant cured epoxy resin according to claim 10, wherein the curing promoter is triphenylphosphine.

12. The flame-retardant cured epoxy resin according to claim 2, wherein the curing agent is melamine-phenol novolac.
